(19) United States
(12) Patent Application Publication
(10) Pub. No.: US 2016/0321706 A1
(43) Pub. Date: Nov. 3, 2016

(54) SYSTEM FOR AUTOMATICALLY UPDATING CONSUMER STATUS IN E-COMMERCE ENVIRONMENTS

(71) Applicant: Andrew Michael Barton, Huntington Beach, CA (US)

(72) Inventor: Andrew Michael Barton, Huntington Beach, CA (US)

(21) Appl. No.: 15/139,857

(22) Filed: Apr. 27, 2016

Related U.S. Application Data
(60) Provisional application No. 62/154,536, filed on Apr. 29, 2015.

(51) Int. Cl. G06Q 30/02; G06Q 30/06

(52) U.S. Cl. CPC G06Q 30/0269; G06Q 30/0613

(57) ABSTRACT

A system and method provides updated consumer status associated with a product or service. Embodiments provide a function in an electronic interface for the consumer to indicate whether they are in the market for or out of the market for purchase of the product/service. In some embodiments, identification of a purchase through a website utilizing the system may automatically change the consumer status to being “out-of-market” so that marketing engines and online campaigners have up to date target leads of relevance.

### CROSS-REFERENCE TO RELATED APPLICATIONS

This application claims benefit under 35 U.S.C. §119(e) of U.S. Provisional Application having Ser. No. 62/154,536 filed Apr. 29, 2015, which is hereby incorporated by reference herein in its entirety.

### BACKGROUND

The embodiments herein relate generally to electronic commerce (e-commerce) systems, and more particularly a system for automatically updating consumer status in an e-commerce environment.

In the field of e-commerce, online marketing campaigns help drive interest and purchase of products or services through online merchant sites. Attracting consumers is usually performed through advertisements that are displayed on third party sites. As is known, sites employ a variety of code to determine which sites show which advertisements. Generally speaking, analytics and data mining are employed to determine what regions or what sites might have the best traffic for a product/service. Other approaches use e-mail address, application profile information or device address tracking to generate lists which are used to target potential buyers. However the current technology suffers from stale information. For example, some code may identify that an online consumer has searched for a particular product, thus adding the consumer to a list. Members of the list continue to receive advertisements related to the product/service based on a preset timeframe (week long, month long, etc.) for a campaign. As may be appreciated, interest in the product/service for many list members may have changed. Thus advertising costs for campaigns are being used to target disinterested prospects creating waste. Embodiments of the subject technology solve these problems.

### SUMMARY

In one aspect, a computer program product for providing an e-commerce based system of providing consumer status for purchase of a product/service comprises a non-transitory computer readable storage medium having computer readable program code embodied therewith. The computer readable program code is configured to: provide for a consumer by a processor, an electronic platform including a profile for the consumer; receive in the profile a status indicator from the consumer for one or more products/services, the status indicator indicating an interest by the consumer to purchase the product/service; retrieve by the processor whether the consumer is currently looking to purchase the product/service or not looking to purchase the product/service; flag in the profile the consumer as having a status of being in the market for or out of the market for purchase of the product/service based on the consumer currently looking to purchase the product/service or not looking to purchase the product/service; and transmit to a merchant the flagged status of the consumer.

In another aspect, a method of providing an e-commerce based system of providing consumer status for purchase of a product/service comprises providing for a consumer by a processor, an electronic platform including a profile for the consumer; receiving in the profile a status indicator from the consumer for one or more products/services, the status indicator indicating an interest by the consumer to purchase the product/service; retrieving by the processor whether the consumer is currently looking to purchase the product/service or not looking to purchase the product/service; flagging in the profile the consumer as having a status of being in the market for or out of the market for purchase of the product/service based on the consumer currently looking to purchase the product/service or not looking to purchase the product/service; and transmitting to a merchant the flagged status of the consumer.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a system for improving updated information of consumer needs for products according to an embodiment of the subject technology.

FIG. 2 is a flowchart of a consumer side method for automated status updates of products the consumer is in-market or out-of-market for according to an embodiment of the subject technology.

FIG. 3 is a flowchart of a merchant side method for automated status updates of products the consumer is in-market or out-of-market for according to an embodiment of the subject technology.

FIG. 4 is a block diagram of a computer system/server according to an embodiment of the subject technology.

FIG. 5 is a block diagram of an e-commerce network according to an embodiment of the subject technology.

### DETAILED DESCRIPTION OF CERTAIN EMBODIMENTS

Embodiments disclosed herein generally provide a system for updating the needs of consumers so that online marketers can update prospects and send marketing campaigns to relevant leads with improved accuracy and efficiency. As will be appreciated, aspects of the system and processes disclosed herein solve problems in the fields of online marketing technology. Online marketing generally works by sending a campaign for a product to a list of e-mail addresses, device IDs and system IDs/cookies. For the most part, an online marketing engine is blind with respect to whether the end recipients in the list are even interested in the product being marketed. The relevance of the members in the audience is completely arbitrary with respect to the product/service. Some current online marketing engines use electronic cookie based data to track when a computing device's IP address clicks on an online event related to a product/service. The address becomes part of a target list. However, the marketing engine and user's administering the engine have no way of knowing whether members in the list are still interested in the product/service. In some instances, the purchase is a one-time event. For example, a consumer may be in the market to purchase a major home appliance. Conventional approaches that track online activity will place the consumer on a list and will keep sending him or her electronic advertisements well after the appliance is purchased. This becomes wasted resources since online marketing campaigns often charge for each display of an advertisement. Embodiments disclosed herein improve the efficiency of online marketing technology.

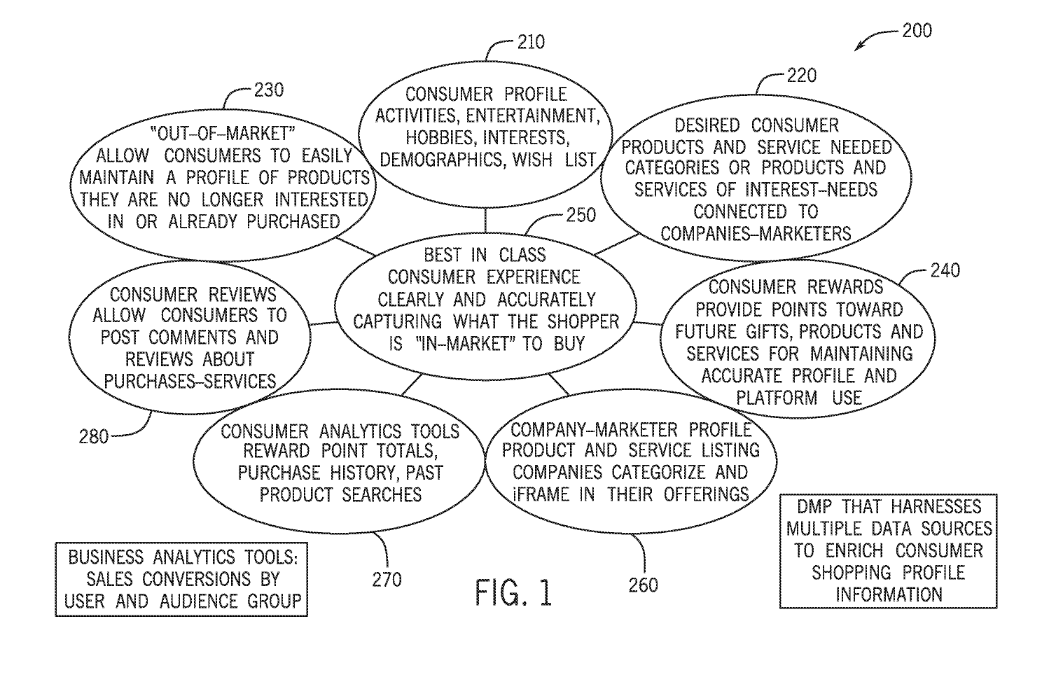

Referring now to FIGS. 1, a system 200 for updating consumer product need status is shown according to an exemplary embodiment. The system 200 may be a centralized electronic platform comprising eight core components. The seven components shown on the perimeter contribute toward the central component representing an electronic consumer interface 250 providing the consumer with means for relaying to e-commerce merchants what products/services the consumer is currently “in-market” (in the market) and “out-of-market” (out of the market) for. In some embodiments, the system 200 may be an electronic online platform accessed via a web portal or mobile device app. In some embodiments, the system 200 may be a software module or plug-in that can be added/loaded onto an e-commerce site/social media site from the user's (consumer's) display user interface so that consumer information is readily available to the host site and updated in response to consumer transactions.

As will be described in more detail below with respect to method embodiments, the consumer may create a user profile 210 which may include information that is important to online marketers. In an exemplary embodiment, components 220 and 230 may be tied to the user profile. The component 220 may include a feature indicating what products and services a consumer is currently interested in purchasing (“in-market”). As will be appreciated, component 220 provides information that is valuable to merchants and online marketers for use with components 240, 260, and 270 to analyze, develop targeted marketing campaigns, and offer rewards to consumers. Likewise, component 230 provides consumers with a feature indicating products/services the consumer has no current interest in purchasing (“out-of-market”). As will also be appreciated, component 230 also provides information valuable to merchants and online marketers which can be used to avoid unlikely leads and budget advertising more efficiently. Component 280 provides a mechanism for consumers to post reviews of products which can also be used for components 240, 260, and 270.

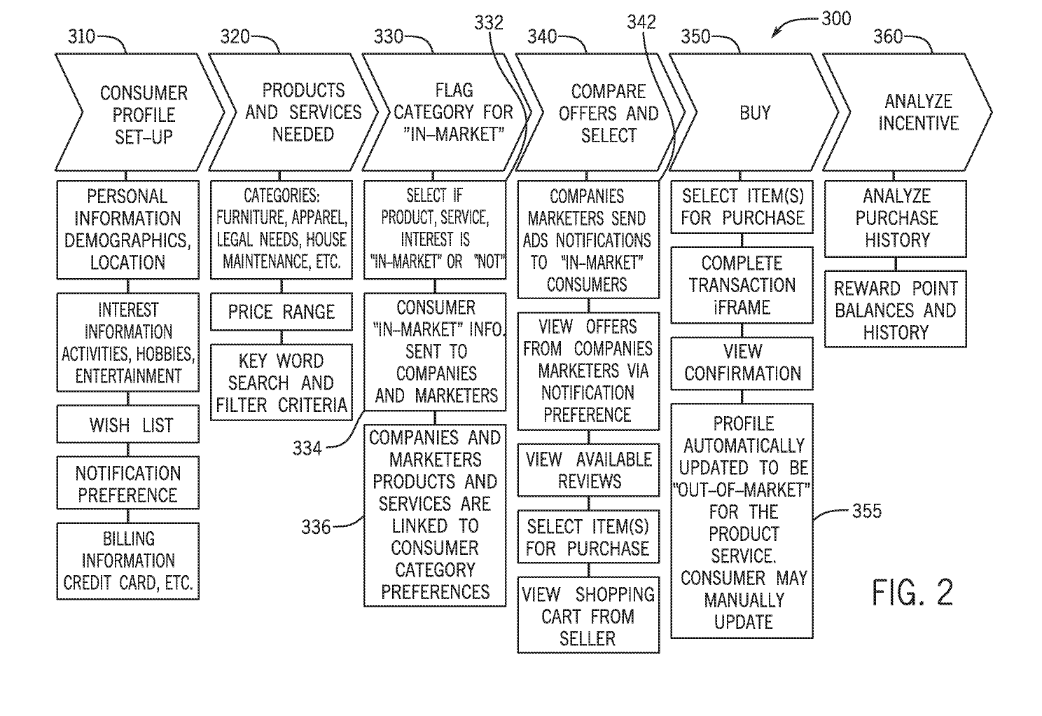

Referring now to FIG. 2, a method 300 for automated status updates of products the consumer is in-market or out-of-market as performed from the consumer side is shown according to an exemplary embodiment. As will be understood, the steps described below are performed by a processor unless otherwise indicated. In block 310, a consumer profile set-up is received. The consumer profile may include personal information, personal interests, a wish list of products/services, user options such as frequency and types of notifications, and billing information. In block 320, user input related to products and services generally wanted by the consumer may be received. Some embodiments allow the consumer to receive offers based on categories of products and price ranges of products/services they have indicated are of interest. A search feature may be included for the consumer to look for certain products, the history of which may be stored for later use by marketing engines.

In an exemplary embodiment, block 330 includes receiving a flag by the consumer of products they are “in-market” for purchasing. In block 332, the consumer may select/deselect products/services of current purchasing interest (or no longer interested in purchasing due to for example, having recently purchased the product or having changed their mind to purchase). In block 334, the current status of a consumer's interest in purchasing a product/service may be forwarded to third parties (marketing engines, campaign managers, merchants, etc.), some of which are subscribed to a service tied to embodiments of the systems disclosed. In some embodiments, block 336 automatically updates company/marketer files of those parties subscribed to a service to reflect the change in consumer status (“in-market” or “out-of-market”). As will be appreciated, advertising campaigns become more efficient in sending advertisements to targeted leads without having to manually refresh lists of targeted leads. The consumer benefits by receiving advertisements related to products they are currently interested in and don't receive advertisements for products they no longer have an interest in. In block 340, the consumer may be provided with advertising campaigns or offers between competing merchants based on their “in-market” status data. Third parties (merchants and service providers) may send (342) advertisements and notifications to those users who have a current “in-market” status to the products and services sold by those third parties. Thus, an impetus to purchase through the system is provided. In some embodiments, a link to purchase a product/service through one of the notifications or advertisements may be provided triggering a shopping cart platform displayed to the user.

In block 350, the system may provide an interface to purchase products on one of the third party e-commerce sites while remaining on the noted platform. In response to a completed purchase, a purchasing signal may be received in block 335 for a product purchased by the consumer through the system. In response to the purchase, the system may automatically update the system to indicate that the consumer is no longer “in-market” for the product/service (depending for example on a user preference set up during for example, block 310). In some embodiments, the system may include an option to flag/unflag after purchase whether the product/service remains as “in-market” status or not. In block 360, purchase history and “in-market” status associated with a user profile may be analyzed for incentive data based on the accuracy of the “in-market” status, which may be provided to 3^{rd} parties.

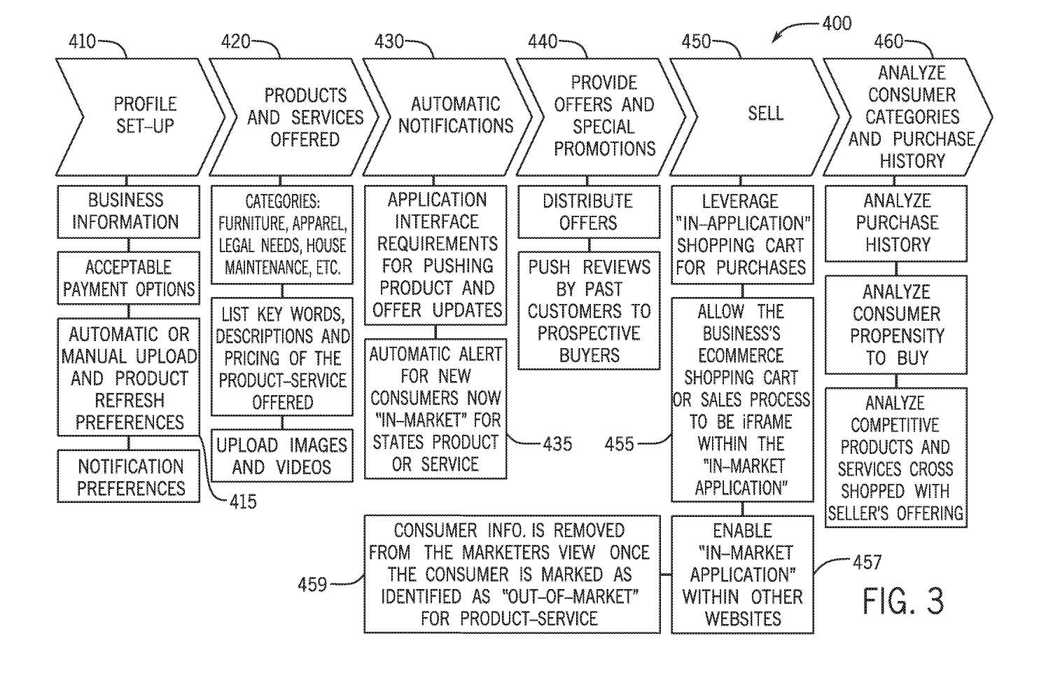

Referring now to FIG. 3, a method 400 from the merchant side for automated status updates of products a consumer is “in-market” or “out-of-market” for is shown according to an exemplary embodiment. As will be understood, the steps described below are performed by a processor unless otherwise indicated. In block 410, a merchant profile set-up is received. The merchant profile may include business information and accepted forms of payment. In block 415, the business may setup preferences which indicate automatic or manual upload of status messages related to consumers that are “in-market”/“out-of-market” for products/services offered by the merchant. A notifications preference function may set how often the merchant receives refreshed lists of leads. In block 420, the merchant may input products and services sold (along with descriptions, pricing, and images). The information can be manually or automatically updated by the merchant based on their profile settings.

In an exemplary embodiment, block 430 includes sending the merchants automatic notifications. In block 435, the merchant may be sent an automatic alert for consumers showing a change in status indicating they are now “in-market” for a product/service offered by the merchant. Based on the merchant profile settings, an automated campaign may be sent to consumers for the respective products/services. As will be appreciated, the timeliness of the notice provides merchants an advantage of getting the consumers attention ahead of those merchants relying on conventional campaign techniques. In block 440, the system may receive advertising campaigns or offers from merchants to distribute to consumers based on their “in-market” status data. Some embodiments include past reviews of products/services pushed to the end consumers.

In block 450, a sales platform may be displayed. In some embodiments, a merchant's purchasing platform may integrate (455) a module or plug-in of the system. In block 457, the “in-market” status feature may be shown within the e-commerce or other web site. In block 459, the system may identify that the purchase may change the consumer's need for the product/service and the “in-market” status may be removed from the consumer's profile in response to purchase and the consumer may be shown as “out-of-status”. As may be appreciated, automated recognition of change in purchasing need and status helps solve the need to eliminate stale leads and advertisements that are no longer relevant to an end consumer.

Referring now to FIG. 4, a schematic of an example of a computer system/server 10 is shown. The computer system/server 10 is shown in the form of a general-purpose computing device. In some embodiments, the computer system/server 10 may be a cloud computing node connected to a cloud computing network (not shown). The computer system/server 10 may be for example, personal computer systems, tablet devices, mobile telephone or smartphone devices, server computer systems, handheld or laptop devices, multiprocessor systems, microprocessor-based systems, set top boxes, programmable consumer electronics, network PCs, and distributed cloud computing environments that include any of the above systems or devices, and the like. The computer system/server 10 may be described in the general context of computer system executable instructions, such as program modules, being executed by a computer system (described for example, below). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The components of the computer system/server 10 may include, but are not limited to, one or more processors or processing units 16, a system memory 28, and a bus 18 that couples various system components including the system memory 28 to the processor 16. The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein (for example as steps related to identifying an update by a consumer of being in-market or out-of-market for a product/service, identifying merchants associated with products/services of updated status, issuing alerts to merchants, and modify recipients of online marketing campaigns based on updated status data).

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. User interfaces and modules/plug-ins including aspects of the “in-market” status recognition and display may be seen through display 24. Such communication can occur via Input/Output (I/O) interfaces 22. In some embodiments, the display 24 is configured for tactile or touch screen operation. A keyboard function may be a digital keyboard accessed via a user interface through the display 24. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

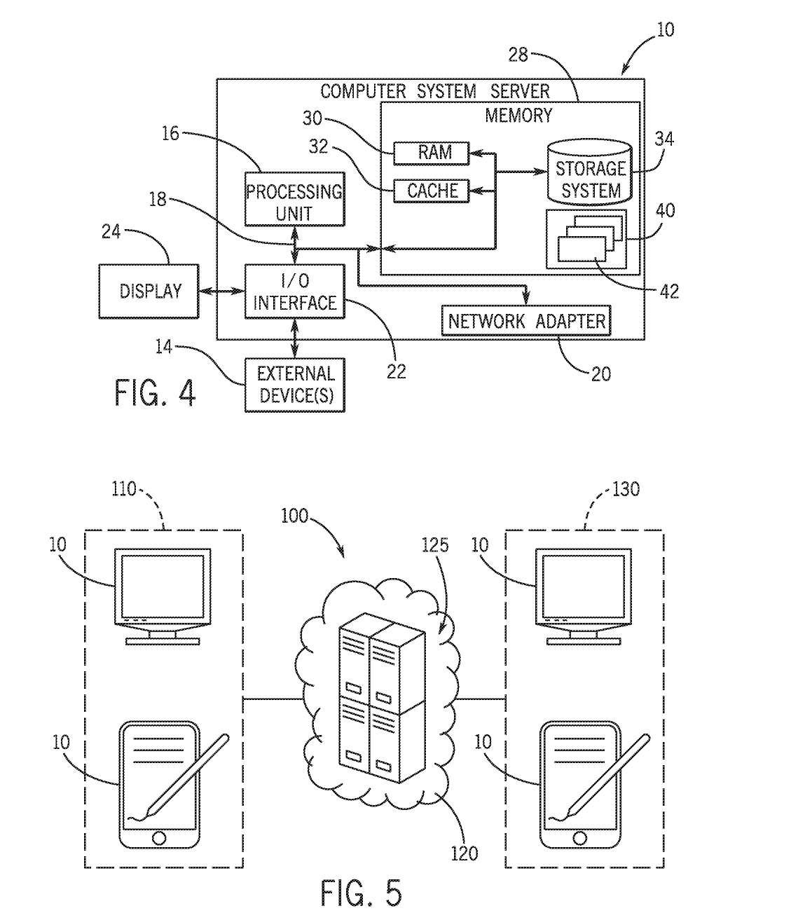

Referring now to FIG. 5, a block diagram of a system 100 for automating the status of consumer interest in a product/service is shown. The system 100 may connect an end user 110 (for example a consumer) to an online merchant 130 through a network 120. The network 120 may include a server 125 storing a software embodiment of the disclosed invention as described above. The end user 110 and online merchant 130 may interact with the system 100 with an electronic device (for example, a PC or mobile device). It will be understood that the electronic device used by the end user and the online merchant 130 and the server 125 may function for example, under the description the computer system/server 10 of FIG. 4. In some embodiments, the network 120 may be a cloud based environment. The end user 110 may interface with a computer 10 from the consumer side to set up his/her profile (as described above), indicate being “in-market” or “out-of-market” for products/services, and generally transact purchases with the online merchant 130. Transactions with the online merchant 130 may trigger automatic status updates in the server 125 as described above.

Aspects of the disclosed invention may take the form of a computer program product embodied in computer readable media having computer readable program code embodied thereon. A computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for providing an e-commerce based system of providing consumer status for purchase of a product/service, the computer program product comprising a non-transitory computer readable storage medium having computer readable program code embodied therewith, the computer readable program code being configured to:
provide for a consumer by a processor, an electronic platform including a profile for the consumer;
receive in the profile a status indicator from the consumer for one or more products/services, the status indicator indicating an interest by the consumer to purchase the product/service;
retrieve by the processor whether the consumer is currently looking to purchase the product/service or not looking to purchase the product/service;
flag in the profile the consumer as having a status of being in the market for or out of the market for purchase of the product/service based on the consumer currently looking to purchase the product/service or not looking to purchase the product/service; and
transmit to a merchant the flagged status of the consumer.

2. The computer program product of claim 1, further comprising computer readable code configured to:
identify a purchase by the consumer of the product/service in an online platform; and
automatically change the flagged status of the profile to being out of the market for the product/service in response to the identified service.

3. The computer program product of claim 1, further comprising computer readable code configured to:
identify the profile having a status for the product/service as being in the market for purchase; and
automatically transmit to the merchant, an updated list including the identified profile having the status for the product/service as being in the market for purchase.

4. The computer program product of claim 3, further comprising computer readable code configured to generate an updated online advertising campaign targeting the identified profile.

5. The computer program product of claim 1, further comprising computer readable code configured to load the computer program product onto a third party website as a plug-in or module.

6. A method of providing an e-commerce based system of providing consumer status for purchase of a product/service, comprising:
providing for a consumer by a processor, an electronic platform including a profile for the consumer;
receiving in the profile a status indicator from the consumer for one or more products/services, the status indicator indicating an interest by the consumer to purchase the product/service;
retrieving by the processor whether the consumer is currently looking to purchase the product/service or not looking to purchase the product/service;
flagging in the profile the consumer as having a status of being in the market for or out of the market for purchase of the product/service based on the consumer currently looking to purchase the product/service or not looking to purchase the product/service; and
transmitting to a merchant the flagged status of the consumer.

7. The method of claim 6, further comprising:
identifying a purchase by the consumer of the product/service in an online platform; and
automatically changing the flagged status of the profile to being out of the market for the product/service in response to the identified service.

8. The method of claim 6, further comprising:
identifying the profile having a status for the product/service as being in the market for purchase; and
automatically transmitting to the merchant, an updated list including the identified profile having the status for the product/service as being in the market for purchase.

9. The method of claim 8, further comprising generating an updated online advertising campaign targeting the identified profile.

10. The method of claim 6, further comprising loading the computer program product onto a third party website as a plug-in or module.
